(19) United States
(12) Patent Application Publication
(10) Pub. No.: US 2009/0112526 A1
(43) Pub. Date: Apr. 30, 2009

(54) SYSTEM AND METHOD FOR SIMULATING FLUID PARTICLE HAVING MULTI-RESOLUTION

(75) Inventors: Janghee KIM, Taejon (KR); Manjai LEE, Seoul (KR); Bon Ki KOO, Taejon (KR); Soon Hyoung PYO, Taejon (KR); Seungtaik OH, Sungnaam (KR); Young Hee KIM, Busan (KR); Byung Seok ROH, Taejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Taejon (KR)

(21) Appl. No.: 12/101,229

(22) Filed: Apr. 11, 2008

(30) Foreign Application Priority Data
Oct. 25, 2007 (KR) 10-2007-107669

(51) Int. Cl. G06G 7/57; G06F 17/50

(52) U.S. Cl. 703/1

(57) ABSTRACT

Provided are a system and method for simulating fluid particles having multi-resolution. In the method, given particle data expressing fluid is analyzed in an fluid particle analyzing module so that data for determining resolutions is obtained. A resolution of each of regions is determined using the obtained data in a resolution level determining module. Particles of each of the regions are reformed to particles corresponding to the resolution of each of the regions using the determined resolution of each of the regions in a fluid particle reforming module. Position data of fluid particles of a next frame is obtained after a simulation using the reformed particles in a multi-resolution fluid simulation module. Therefore, the fluid simulation having the high resolution can be performed in limited computing resources by applying different resolutions to each of the regions.

### BACKGROUND OF THE INVENTION

1. Field of the Invention

The present invention relates to a system and method for simulating fluid particles, and more particularly, to a system and method for simulating fluid particles having multi-resolution, in which the multi-resolution is applied to the fluid particles used in an animation and a movie to express simulation results more detailedly and accurately.

The present invention has been derived from research undertaken as a part of the development of IT new growth engine core technology development project by the Ministry of Information and Communication and the Institute for Information Technology Advancement (IITA), Republic of Korea (Project No. 2004-S-606, Title: Development of fluid simulation technology for special image effect).

2. Description of the Related Art

Efforts to embody more realistic and expressive expressions in scenes in which fluid appears so as to actually express various fluid scenes are in progress during the production of an animated film.

Hence, many techniques for actually expressing the various fluid scenes in various movies and animations are under development. However, there is a limitation that the various fluid scenes are actually expressed, and therefore, the expressions of the fluid scenes are not satisfied by a user in a large portion of the scenes.

### SUMMARY OF THE INVENTION

Accordingly, the present invention is directed to a system and method for simulating fluid particles having multi-resolution, which differ in resolution by region to reform the fluid particles and then performs a fluid simulation using the reformed fluid particles.

It is an object of the present invention to provide a method for expressing fluid simulation results more detailedly and accurately, which are used for animations and movies, the method including: analyzing a configuration of fluid data expressed in a particle shape; determining a resolution of each of regions in which the simulation is being performed using the analyzed configuration of the fluid data; reforming fluid particles using the determined resolution; and performing multi-resolution fluid simulation using the reformed fluid particles.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for simulating fluid particles having multi-resolution, the system including: an fluid particle analyzing module analyzing distribution of fluid particles, e.g., particles of water representing fluid existing in external environment; a resolution level determining module determining simulation resolution of each of regions using the analyzed data; a fluid particle reforming module reforming fluid particles so that the fluid particles are suitable for the determined resolution; and a multi-resolution fluid simulation module performing a fluid simulation using the fluid particles constituted as described above.

In another aspect of the present invention, there is provided a method simulating fluid particles having multi-resolution, the method including: analyzing distribution of fluid particles, e.g., particles of water representing fluid existing in external environment; determining simulation resolution of each of regions using the analyzed data; reforming fluid particles so that the fluid particles are suitable for the determined resolution; and performing a fluid simulation using the fluid particles constituted as described above.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a block diagram of a system for simulating fluid particles having multi-resolution according to an embodiment of the present invention; and

FIG. 2 illustrates a flowchart of a procedure of simulating fluid particles having multi-resolution according to an embodiment of the present invention.

### DETAILED DESCRIPTION OF THE INVENTION

Hereinafter, a system and method for simulating fluid particles having multi-resolution will be described with reference to the accompanying drawings.

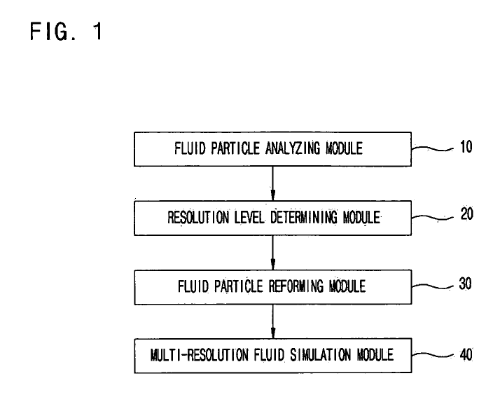

FIG. 1 illustrates a block diagram of a system for simulating fluid particles having multi-resolution according to an embodiment of the present invention.

Referring to FIG. 1, a system for simulating fluid particles having multi-resolution according to the present invention includes a fluid particle analyzing module 10, a resolution level determining module 20, a fluid particle reforming module 30, and a multi-resolution fluid simulation module 40.

The fluid particle analyzing module 10 analyzes configuration data of the fluid particles to be used for determining resolutions using position data of the particles obtained from simulation results of a previous frame. The resolution level determining module 20 determines a resolution of each of regions in which the simulation is being performed using the analyzed configuration data of the fluid particles. The fluid particle reforming module 30 reforms the fluid particles of each of the regions so that the fluid particles are suitable for the determined resolution. The multi-resolution fluid simulation module 40 tracks and calculates positions of each of particles of a next frame using the reformed fluid particles having various resolutions.

The fluid particle analyzing module 10 utilizes particle data generated using an external three-dimensional fluid simulator as input data. The fluid particle analyzing module 10 analyzes how the particles are distributed and calculates distances from a fluid surface to the particles to store the calculated results as one completed data. The fluid particle analyzing module 10 puts more weight on interests specified by a user to complete data to be used for a next module. Such completed data is used for determining levels of the resolutions in the resolution level determining module 20.

The resolution level determining module 20 determines how a level of a resolution of each of the regions is set using the obtained data. In general, the fluid surface is set to a portion, which has the highest resolution for viable effects. Hence, the resolution of each of the regions is determined such that the portion can be expressed in most detail and maintains accuracy and stability in an entire simulation. The resolution level determining module 20 determines types and quantities of currently available computing resources to search an executable optimum resolution. The fluid particle reforming module 30 uses the resolution determined through the above-described processes.

The fluid particle reforming module 30 again synthesizes and reforms current distribution patterns of the fluid particles using the resolution determined through the resolution level determining module 20. A current configuration of the fluid particles is not configured to be suitable for the resolution determined through the resolution level determining module 20. Hence, the configuration of the fluid particles needs to be reformed based on the determined resolution. The fluid particle reforming module 30 first searches the resolution of each of the regions and analyzes the configuration of the fluid particles. Then, the fluid particle reforming module 30 reforms the particles in an optimum form, which can maintain previous volumes and shapes as it is and correspond to the determined resolution. Here, characteristics and properties of the existing particles may be modified, and new particles may be added or the existing particles may be removed. Thereafter, the multi-resolution fluid simulation module 40 tracks portions of particles of the next frame.

The multi-resolution fluid simulation module 40 tracks the portions of the particles of the next frame using the fluid particles reformed through the fluid particle reforming module 30. The fluid particles have various types. Hence, it is difficult to easily obtain the tracked results using a general simulation method. As a result, the multi-resolution fluid simulation module 40 calculates the portions of the particles of the next frame in consideration of the various particle types in the simulation method. The particle types act on the calculation results when magnitude of force which affects adjacent particles is calculated. The multi-resolution fluid simulation module 40 adequately adjusts the magnitude of the force to perform an accurate and stable simulation. Therefore, the portions of the particles of the next frame are accurately tracked.

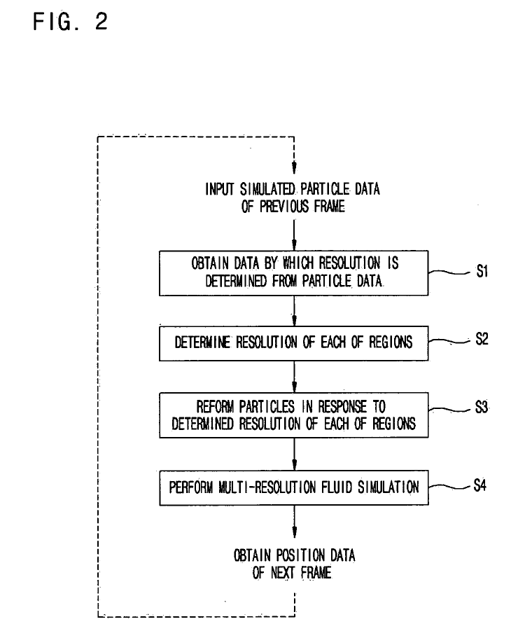

FIG. 2 illustrates a flowchart of a procedure of simulating fluid particles having multi-resolution according to an embodiment of the present invention.

Referring to FIG. 2, particle data simulated by a previous frame is received as input data. The received particle data is analyzed into each of components in the fluid particle analyzing module 10 illustrated in FIG. 1. The fluid particle analyzing module 10 distinguishes the received phase data of fluid particles. In actuality, a fluid surface stands out from an interior fluid. Thus, the fluid surface must be carefully expressed as compared with the interior fluid. The fluid particle analyzing module 10 analyzes how far the fluid particles come from the fluid surface to generate the analyzed results. In addition, the fluid particle analyzing module 10 may receive data of a portion in which a user is interested and classifies the particles according to the user's interest level with respect to the received data to generate new data. Thereafter, in operation S1, the resolution level determining module 20 illustrated in FIG. 1 uses the data analyzed through the fluid particle analyzing module 10.

The resolution level determining module 20 sets the level of the resolution suitable for each of regions using the analyzed fluid particle data. A portion that is considered to be the most important and must be accurately expressed applies a high resolution, and a portion that is considered to be less important applies a low resolution. Here, the important thing is that a resolution of a boundary surface between adjacent regions must be harmonious such that it does not interfere with the simulation. Otherwise, it is impossible to embody the accurate simulation required by a user. In operation S2, resolution data of each of the regions is transmitted to the fluid particle reforming module 30 illustrated in FIG. 1 when the resolution of each of the regions is determined.

The fluid particle reforming module 30 reforms particles of the corresponding regions using the received resolution data of each of the regions to again set the reformed particles to particles suitable for each of the regions. Here, it is important to notice that the reformed particles must have the same volume and shape as the previous particles. Otherwise, it is impossible to embody an inartificial simulation because continuity between the reformed particles and the previous particles is broken down. Hence, in operation S3, the reformed particles must be maintained from the previous particles in the continuity and be modified only in a resolution.

The multi-resolution fluid simulation module 40 illustrated in FIG. 1 performs a simulation for tracking position data of particles of a next frame using the reformed particles. Only one type of particles is not transmitted from the fluid particle reforming module 30. It is impossible to embody the inartificial simulation using only one type of the particles. The multi-resolution fluid simulation module 40 inartificially simulates fluid particles having various resolutions to track the position data of the particles of the next frame. In operation S4, the fluid particle analyzing module 10 again receives the tracked position data of the particles to repeat the same processes. The present invention is not limited to any particular methodology of each of modules.

As described above, in the system and method for simulating the fluid particles having multi-resolution according to the present invention, the fluid simulation having the high resolution can be performed in limited computing resources by applying different resolutions to each of the regions. In addition, the detailed fluid surface and portions which are difficult to express using existing fluid simulation technologies can be expressed to produce expressive animations.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for simulating fluid particles having multi-resolution, the system comprising:
an fluid particle analyzing module analyzing given particle data expressing fluid to obtain data for determining resolutions;
a resolution level determining module determining a resolution of each of regions using the obtained data;
a fluid particle reforming module reforming particles of each of the regions to particles corresponding to the resolution of each of the regions using the determined resolution of each of the regions; and
a multi-resolution fluid simulation module obtaining positions of fluid particles of a next frame after performing a simulation using the reformed particles.

2. A method for simulating fluid particles having multi-resolution, the method comprising:
analyzing given particle data expressing fluid in an fluid particle analyzing module to obtain data for determining resolutions;
determining a resolution of each of regions using the obtained data in a resolution level determining module;
reforming particles of each of the regions to particles corresponding to the resolution of each of the regions using the determined resolution of each of the regions in a fluid particle reforming module; and
a multi-resolution fluid simulation module obtaining position data of fluid particles of a next frame after performing a simulation using the reformed particles in a multi-resolution fluid simulation module.

3. The method of claim 2, wherein the data for determining the resolutions is determined comprises position data of a corresponding particle obtained from the particle data, distribution data analyzed using the position data, and distance data from a fluid surface to the corresponding particle.

4. The method of claim 3, wherein the data for determining the resolutions further comprises weight data with respect to the resolutions.

5. The method of claim 2, wherein, in the determining of the resolution of each of the regions, a fluid surface is determined at a highest resolution in compared with another region.

6. The method of claim 5, wherein, in the determining of the resolution of each of the regions, a difference of resolutions between a corresponding region and an adjacent region is determined within a setting value.

7. The method of claim 2, wherein, in the reforming of the particles of each of the regions to particles corresponding to the resolution of each of the regions, previous volumes and shapes of the particles are maintained when the particles are reformed after analyzing the resolution of each of the regions and a configuration of the particles.

8. The method of claim 2, wherein the simulation is performed in response to particle types.
